(19) United States
(12) Patent Application Publication
(10) Pub. No.: US 2019/0155028 A1
(43) Pub. Date: May 23, 2019

(54) HOLOGRAPHIC HEADS UP DISPLAY

(71) Applicant: WayRay SA, Zurich (CH)

(72) Inventor: Mikhail Svarichevsky, Zurich (CH)

(21) Appl. No.: 16/137,407

(22) Filed: Sep. 20, 2018

Related U.S. Application Data
(60) Provisional application No. 62/561,147, filed on Sep. 20, 2017.

(51) Int. Cl. G02B 27/01; G02B 27/18; G02B 27/10

(52) U.S. Cl. CPC G02B 27/0103; G02B 27/18; G02B 27/0149; G02B 2027/013; G02B 2027/0105; G02B 2027/0154; G02B 27/1046

(57) ABSTRACT

Apparatuses and systems associated with holographic heads up display design for vehicles are disclosed herein. In embodiments, an apparatus may include projection mechanism to produce an arrangement of light and project the arrangement of light on a first side of a combiner. The combiner may include a holographic transmissive combiner that receives the arrangement of light on the first side of the combiner and produces an image on a second side of the combiner that is directed to an observer. Other embodiments may be described and/or claimed.

### RELATED APPLICATIONS

The present application claims priority to U.S. Provisional Patent Application No. 62/561,147, filed Sep. 20, 2017, entitled “HOLOGRAPHIC HEADS UP DISPLAY”, the entire disclosure of which is hereby incorporated by reference.

### TECHNICAL FIELD

The present disclosure relates to the field of displays. More particularly, the present disclosure relates to holographic heads up display design for vehicles.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

As display technology has advanced, vehicle manufacturers have implemented holographic heads up displays in vehicles to replace mechanical and electronic displays. The legacy holographic heads up displays rely on a partially reflective combiner to produce images. In automotive application when this partial reflector is integrated in a windshield (partially reflective foil or wedge PVB) this leads to small field of view (not larger than 10*5°) and/or large optics volume (7 liters or larger). One way of reducing system volume is by using reflective holographic combiner placed at the windshield. By implementing this approach, the volume of the optical system is reduced because part of the optical power is now on the windshield which is closer to the observer. The volume is smaller but still significant because the distance from last optical element to the observer's eye is still 700-900 millimeters (mm) in a typical car.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example heads up display implemented in a vehicle, according to various embodiments.

FIG. 2 illustrates a block diagram of an example heads up display system, according to various embodiments.

FIG. 3 illustrates an example normal arrangement of a heads up display, according to various embodiments.

FIG. 4 illustrates an example vertical arrangement of a heads up display, according to various embodiments.

FIG. 5 illustrates an example mirrored arrangement of a heads up display, according to various embodiments.

FIG. 6 illustrates another example arrangement of a heads up display, according to various embodiments.

### DETAILED DESCRIPTION

Apparatuses and systems associated with holographic heads up display design for vehicles are disclosed herein. In embodiments, an apparatus may include a projection mechanism to produce an arrangement of light and project the arrangement of light on a first side of a combiner. The combiner may comprise a holographic transmissive combiner that receives the arrangement of light on the first side of the combiner and produces an image that is visible through a second side of the combiner that is directed to an observer. The holographic transmissive combiner may be located closer to an observer, and/or may be smaller, than the partially reflective combiners of the legacy holographic heads up displays with comparable field of view and/or combiner optical power.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

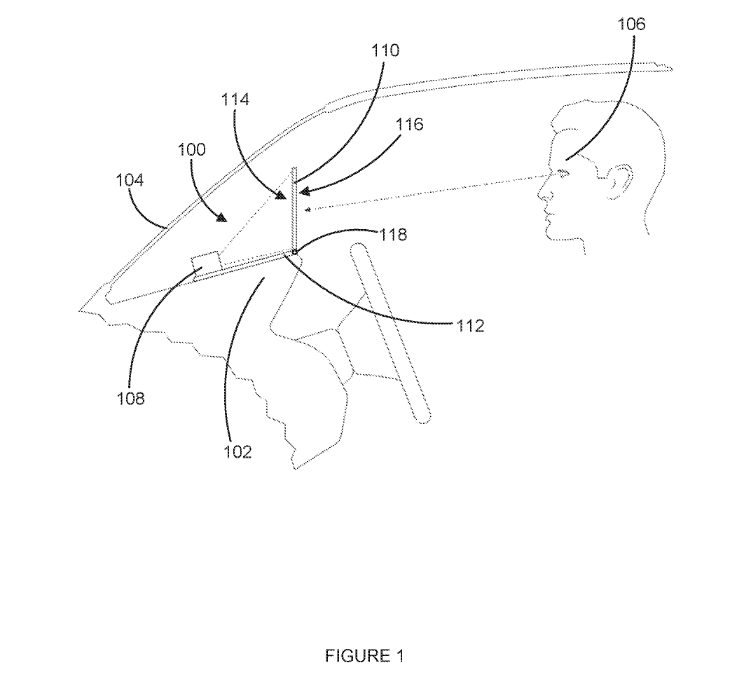

FIG. 1 illustrates an example heads up display (HUD) 100 implemented in a vehicle, according to various embodiments. The HUD 100, or portions thereof, may be positioned on a surface of the vehicle, mounted to a surface of the vehicle, implemented within a portion of the vehicle, or some combination thereof. In the illustrated embodiment, the HUD 100 is illustrated as being positioned on a dashboard 102 of the vehicle. In particular, the HUD 100 is positioned between a windshield 104 of the vehicle and an observer 106, where the observer 106 is located within a driver's seat of the vehicle. The HUD 100 is located closer to the observer 106 than the windshield 104 is located to the observer 106. In other embodiments, the HUD 100, or some portion thereof, may be located closer to the observer 106 than shown in the illustrated embodiment. Further, in some embodiments, a combiner 110 of the HUD 100 may be located between 25.4 centimeters (10 inches) and 114.3 centimeters (45 inches) from the observer 106. In other embodiments, the combiner 110 may be located between 25.4 centimeters (10 inches) and 76.2 centimeters (30 inches) from the observer 106. The distance between the combiner 110 and the observer 106 may be less than the distance between the partially reflective combiner of the legacy holographic heads up display systems and a corresponding observer located within a driver's seat of the vehicle.

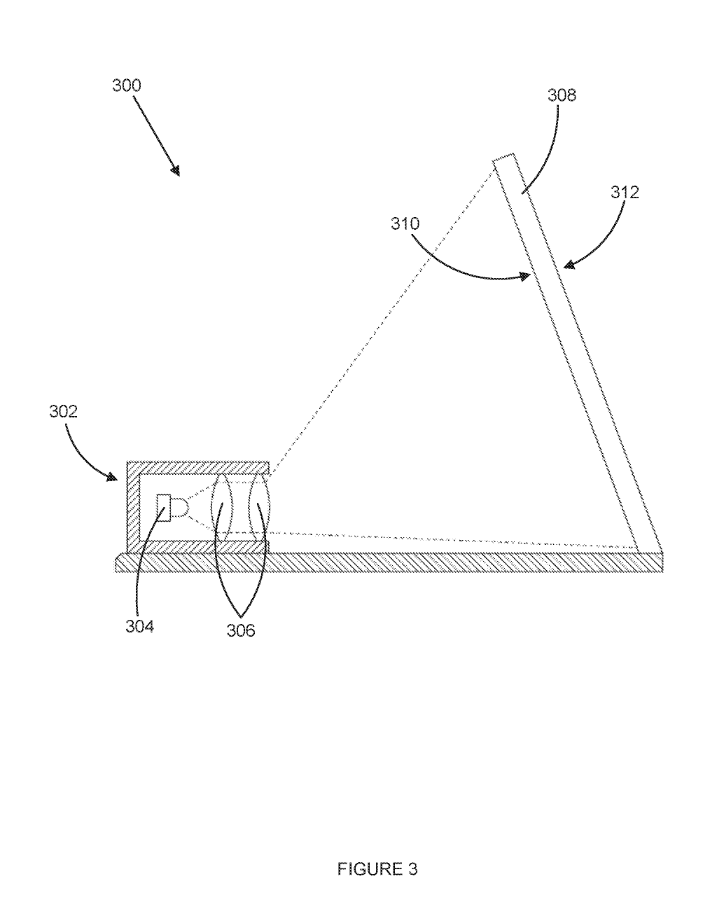

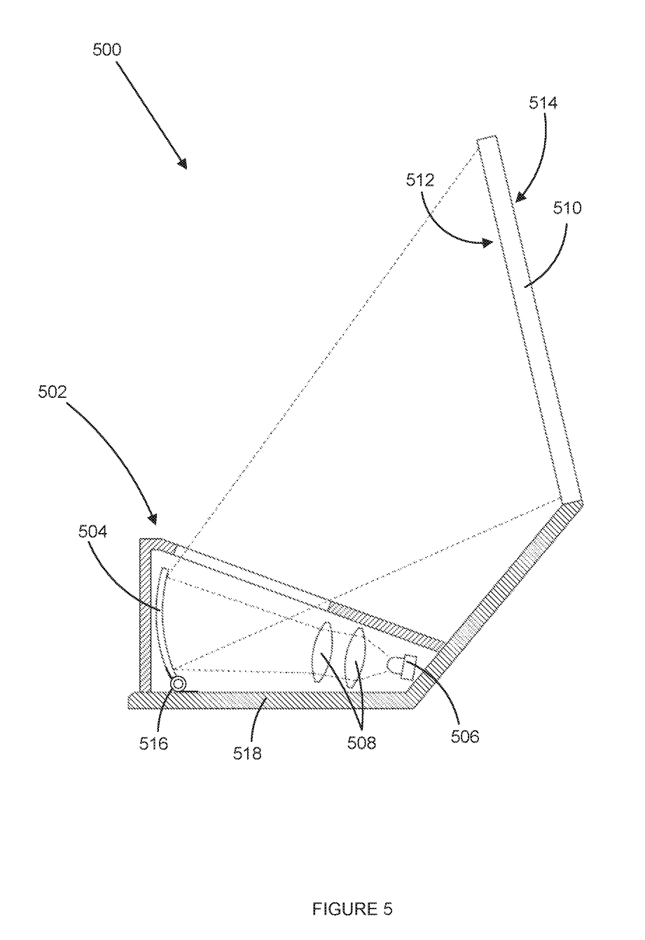

The HUD 100 may include a projection mechanism 108. The projection mechanism 108 may include a projection matrix (see the projection matrix 304 (FIG. 3), and/or the projection matrix 506 (FIG. 5)) to produce the arrangement of light. The projection matrix may include a thin-film transistor display, a liquid crystal display, a liquid crystal on silicon matrix, a dot matrix display, or some combination thereof. The projection mechanism 108 may further include one or more intermediate image planes that may include diffusers (such as a non-holographic diffuser or a holographic diffuser). The intermediate image planes may be located between the projection matrix and the combiner 110.

In some embodiments, the projection mechanism 108 may include one or more lenses, mirrors, diffractive optical elements, or some combination thereof. The lenses, mirrors, and/or diffractive optical elements may direct the arrangement of light produced by the projection matrix and/or the intermediate image planes on the combiner 110.

The HUD 100 may further include the combiner 110. The combiner 110 may be located between the projection mechanism 108 and the observer 106. The combiner 110 may be a holographic transmissive combiner. The holographic transmissive combiner may include a photopolymer and a mechanical substrate. The photopolymer may be in sheet form, may be included in a photopolymer region of the holographic transmissive combiner, may be included in a photopolymer layer of the holographic transmissive combiner, or some combination thereof. The photopolymer sheet, region, and/or layer may have a thickness of between 5 micrometers (196.85 microinches) and 100 micrometers (3.93701 milliinches). The mechanical substrate may be a polycarbonate substrate, a glass substrate, or some combination thereof. The mechanical substrate may have a thickness of between 1 millimeter (39.3701 milliinches) and 10 millimeters (0.393701 inches). The photopolymer sheet may be laminated to the mechanical substrate to produce the holographic transmissive combiner. In some embodiments, the photopolymer may be located between a first mechanical substrate on a first side of the photopolymer and a second mechanical substrate on a second, opposing side of the photopolymer, wherein the first mechanical substrate and the second mechanical substrate may protect the photopolymer.

The combiner 110 may be transparent, such that the observer 106 may look through the combiner 110 and see objects through the other side of the combiner 110 from the observer 106. The combiner 110 may include a holographic transmissive grating (not shown) to receive an arrangement of light on a first side 114 of the combiner 110 and output an image, based on the arrangement of light, visible through a second side 116 of the combiner 110.

The projection mechanism 108 may project the arrangement of light onto a first side 114 of the combiner 110. The combiner 110 may translate the arrangement of light through the combiner 110 and produce an image on a second side 116 of the combiner 110 based on the arrangement of light, wherein the second side 116 of the combiner 110 is opposite to the first side 114. In particular, the holographic transmissive grating may operate on the arrangement of light as the arrangement of light is translated through the combiner 110 to produce the image on the second side 116 of the combiner 110. The combiner 110 may project the image from the second side 116 of the combiner 110 to the observer 106.

The combiner 110 may be smaller in size than the windshield 104. In some embodiments, the combiner 110 may have a height between 2.54 centimeters (1 inch) and 25.4 centimeters (10 inches), and may have a width between 7.62 centimeters (3 inches) and 63.5 centimeters (25 inches). In other embodiments, the combiner may have a height between 12.7 centimeters (5 inches) and 50.8 centimeters (20 inches), and may have a width between 12.7 centimeters (5 inches) and 63.5 centimeters (25 inches). The size of the combiner 110 may be smaller than partially reflective combiners in legacy holographic heads up displays due to the utilization of the holographic transmissive combiner. In particular, the partially reflective combiners of the legacy holographic heads up displays must be larger than the combiner 110 to produce a clear image for viewing by an observer 106.

The combiner 110 may be any different profile, including, but not limited to, being rectangular, circular, square, oval-shaped, or some combination thereof. The combiner 110 may be flat, wherein the arrangement of light may be projected onto a flat first side 114 of the combiner 110 and may produce an image at a flat second side 116 of the combiner 110. In other embodiments, one or both of the first side 114 (on which the arrangement of light is projected) and the second side 116 (at which the image is produced) of the combiner 110 may be curved. For example, the combiner 110 may be cylindrical-shaped or spherical-shaped. In some embodiments, the combiner 110 may have different radii of curvature about the combiner 110, such that a gradient of curvature may differ around the circumference of the combiner 110. For example, the first side 114 of the combiner 110 may have a different gradient of curvature than the second side 116 of the combiner 110. In some embodiments, having the combiner 110 being curved may reduce optical aberration of the image on the second side 116 of the combiner 110 (as experienced by the observer 106), may provide for easier application of film lamination to the combiner 110, or some combination thereof.

The HUD 100 may further include a base 112. The projection mechanism 108 and the combiner 110 may be coupled to the base 112 and may extend from a side of the base 112. The base 112 may maintain a certain distance between the projection mechanism 108 and the combiner 110. The distance may be selected such that the arrangement of light is properly projected on the first side 114 of the combiner 110 to produce the image on the second side 116 of the combiner 110. The base 112 may further include a means for mounting the HUD 100 to the vehicle, such as epoxy, fasteners, adhesive material, non-slip material, or some combination thereof.

In some embodiments, the HUD 100 may be collapsible. In these embodiments, the combiner 110 may be folded against the base 112 and may extend along the base 112 when folded. The combiner 110 may be folded about an edge of the combiner 110 attached to the base 112 to extend along the base 112. In particular, the combiner 110 may be attached to the base 112 via a hinge 118 that allows the combiner 110 to be rotated about the hinge 118. The HUD 100 may be collapsed for storage purposes when the HUD 100 is not in operation. In some of these embodiments, the projection mechanism 108 may further be retracted into the base 112 or folded against the base 112. Further, in some embodiments, the hinge 118 may be omitted.

In some embodiments, the base 112 may be omitted. In these embodiments, the projection mechanism 108 and the combiner 110 may be directly positioned on a surface of the vehicle, mounted to the vehicle, implemented into a portion of the vehicle, or some combination thereof. The projection mechanism 108 and the combiner 110 may be positioned on the surface of the vehicle, mounted to the vehicle, and or implemented into the portion of the vehicle at the certain distance to ensure that the arrangement light is properly projected on the first side 114 of the combiner 110. In these embodiments, the projection mechanism 108 and/or the combiner 110 may be folded against the vehicle and/or retracted into the vehicle for storage when the HUD 100 is not in operation.

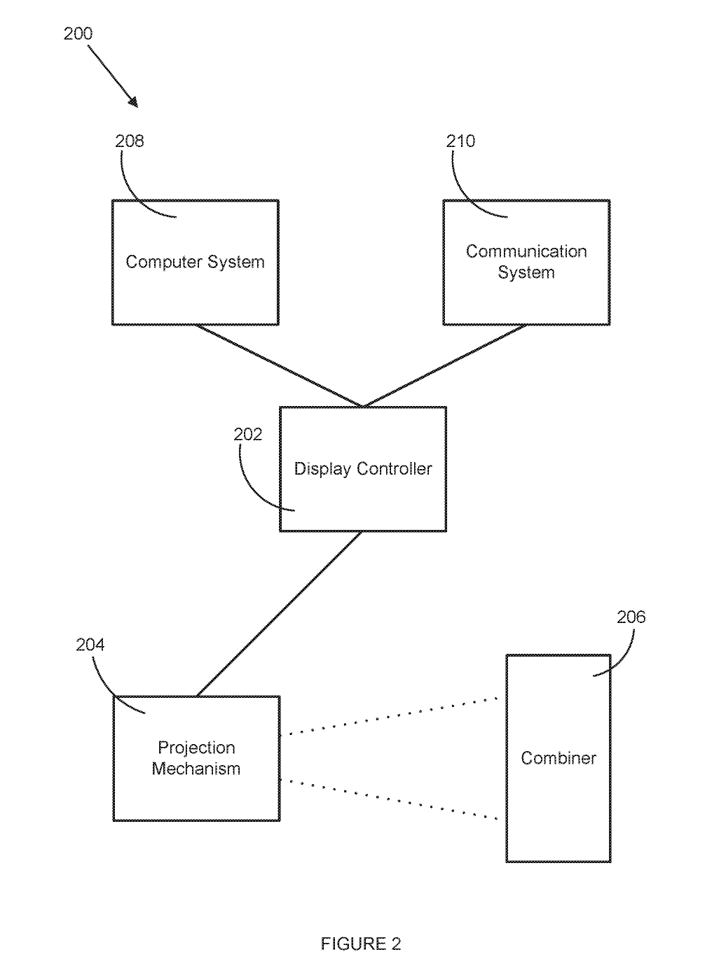

FIG. 2 illustrates a block diagram of an example HUD system 200, according to various embodiments. The HUD system 200 may include a display controller 202. The display controller 202 may include a processor, electronic components, circuitry, or some combination thereof, that is to control an image produced by the HUD system 200. The display controller 202 may receive an indication of an image to be displayed by the HUD system 200 and produce a signal that is utilized by the projection mechanism 204 to produce an arrangement of light that causes the image to be displayed by the HUD system 200. For example, the display controller 202 may receive an indication that the HUD system 200 is to display that the vehicle is traveling at 35 miles per hour (MPH). The display controller 202 may generate a signal, that the display controller 202 transmits to the projection mechanism 204, that causes the projection mechanism 204 to produce an arrangement of light that causes the image to be displayed on a combiner 206 of the HUD system 200 to include “35” and “MPH”.

The display controller 202 may be part of a vehicle in which the HUD system 200 is located, may be physically separate from the vehicle and communicatively coupled (wiredly or wirelessly) to the vehicle, may be physically separate and communicatively isolated from the vehicle, or some combination thereof. In some embodiments, the display controller 202 may be implemented within the projection mechanism 204.

In embodiments where the display controller 202 is part of the vehicle and/or communicatively coupled to the vehicle, the display controller 202 may be communicatively coupled to a computer system 208 of the vehicle. The display controller 202 may retrieve information associated with the vehicle (such as a state of the vehicle) from the computer system 208 of the vehicle and utilize the information to generate a signal that causes the projection mechanism 204 to produce a certain arrangement of light. For example, the display controller 202 may retrieve information from the computer system 208 that indicates that the vehicle is traveling at 35 MPH. The display controller 202 may determine that the HUD system 200 is to display “35” and “MPH” based on the information and may generate a signal that causes the projection mechanism 204 to produce an arrangement of light that causes the HUD system 200 to display “35” and “MPH”.

In embodiments where the display controller 202 is not part of the vehicle and is communicatively isolated from the vehicle, the display controller 202 may be wirelessly communicatively coupled to a communication system 210, including, but not limited to, a global positioning system, a cellular system, other systems able to identify a location of the vehicle, or some combination thereof. The display controller 202 may retrieve information from the communication system 210 and utilize the information to generate a signal that causes the projection mechanism 204 to produce a certain arrangement of light. For example, the display controller 202 may retrieve information from the communication system 210 that indicates directions for the vehicle to travel to a destination. The display controller 202 may determine a certain image to be displayed on a combiner 206 of the HUD system 200 to indicate at least a portion of the directions and may generate a signal that causes the projection mechanism 204 to produce an arrangement of light that causes the combiner 206 to display the image.

The HUD system 200 may further include the projection mechanism 204. The projection mechanism 204 may include one or more of the features of the projection mechanism 108 (FIG. 1). The projection mechanism 204 may receive a signal from the display controller 202 and may produce an arrangement of light based on the signal. For example, the signal may indicate an arrangement of pixels within a projection matrix of the projection mechanism 204 to produce the arrangement of light. The projection mechanism 204 may arrange the pixels within the projection matrix in accordance with the indication of the signal to produce the arrangement of light, which causes the combiner 206 to display a certain image associated with the arrangement of light.

The HUD system 200 may further include the combiner 206. The combiner 206 may include one or more of the features of the combiner 110 (FIG. 1). The projection mechanism 204 may direct the arrangement of light on a first side of the combiner 206. The combiner 206 may display an image associated with the arrangement of light on a second side of the combiner 206.

FIG. 3 illustrates an example normal arrangement of a HUD 300, according to various embodiments. The HUD 300 may include one or more of the features of the HUD 100 (FIG. 1), the HUD system 200 (FIG. 2), or some combination thereof.

The HUD 300 may include a projection mechanism 302. The projection mechanism 302 may include one or more of the features of the projection mechanism 108 (FIG. 1), the projection mechanism 204 (FIG. 2), or some combination thereof. The projection mechanism 302 may receive a signal from a display controller (such as the display controller 202 (FIG. 2)) and produce an arrangement of light based on the signal.

The projection mechanism 302 may include a projection matrix 304. The projection matrix 304 may include one or more of the features of the projection matrix described in relation to FIG. 1. In particular, the projection matrix 304 may include a thin-film transistor display, a liquid crystal display, a liquid crystal on silicon matrix, a dot matrix display, or some combination thereof. The projection matrix 304 may include a plurality of pixels, wherein each pixel may output light. Each of the pixels may output multiple different frequencies and/or intensities of light. The signal received from the display controller may define certain frequencies and/or intensities of light to be output by each of the pixels of the projection matrix 304. In other embodiments, the projection matrix 304 (or some other element of the projection mechanism 302) may determine the frequencies and/or intensities of light to be output by each of the pixels of the projection matrix 304 based on the signal. The projection matrix 304 may configure each of the pixels to output corresponding frequencies and/or intensities of light based on the signal. The frequencies and/or intensities of light output by the pixels may correspond to an image to be displayed on a second side 312 of a combiner 308 of the HUD 300. In particular, the light output by the pixels may be an arrangement of light to produce the image to be displayed on the second side 312 of the combiner 308 of the HUD 300.

In some embodiments, the projection matrix 304 may include a filter positioned in front of a light source, such that light emitted from the light source passes through the filter. The filter may include multiple pixels, where each of the pixels is to alter the light emitted from the light source to certain frequencies and/or intensities of light corresponding to each of the pixels as the light passes through the filter. The signal may define which frequencies and/or intensities of light to which each of the pixels are to alter the light.

The projection mechanism 302 may further include projection optics 306. The projection optics 306 may include one or more lenses, mirrors, diffractive optical elements, or some combination thereof. The light emitted from the projection matrix 304 may directed at the projection optics 306. The projection optics 306 may diffract, focus, project, and/or perform another operation on the light emitted from the projection matrix 304 as the light passes through the projection optics 306. In the illustrated embodiments, the projection optics 306 may include one or more lenses that project the light emitted from the projection matrix 304 on a combiner 308 of the HUD 300. In particular, the projection optics 306 may project an arrangement of light at the combiner 308, the arrangement of light to be converted into an image by the combiner 308.

The HUD 300 may further include the combiner 308. The combiner 308 may include one or more of the features of the combiner 110 (FIG. 1), the combiner 206 (FIG. 2), or some combination thereof. The combiner 308 may be positioned in a normal arrangement. In the normal arrangement, the combiner 308 may extend substantially perpendicularly (within five degrees) to a center of the arrangement of light projected on the combiner 308. In particular, a first side 310 of the combiner 308 on which the arrangement of light is projected may extend substantially perpendicular to light located at the center of the arrangement of light. In embodiments where the first side 310 of the combiner 308 on which the arrangement of light is projected is curved, an imaginary line bisecting the opposing ends of the first side 310 may be substantially perpendicular to the light located at the center of the arrangement of light, while the portion of the combiner 308 on which the light located at the center of the arrangement is projected may or may not be substantially perpendicular to the light.

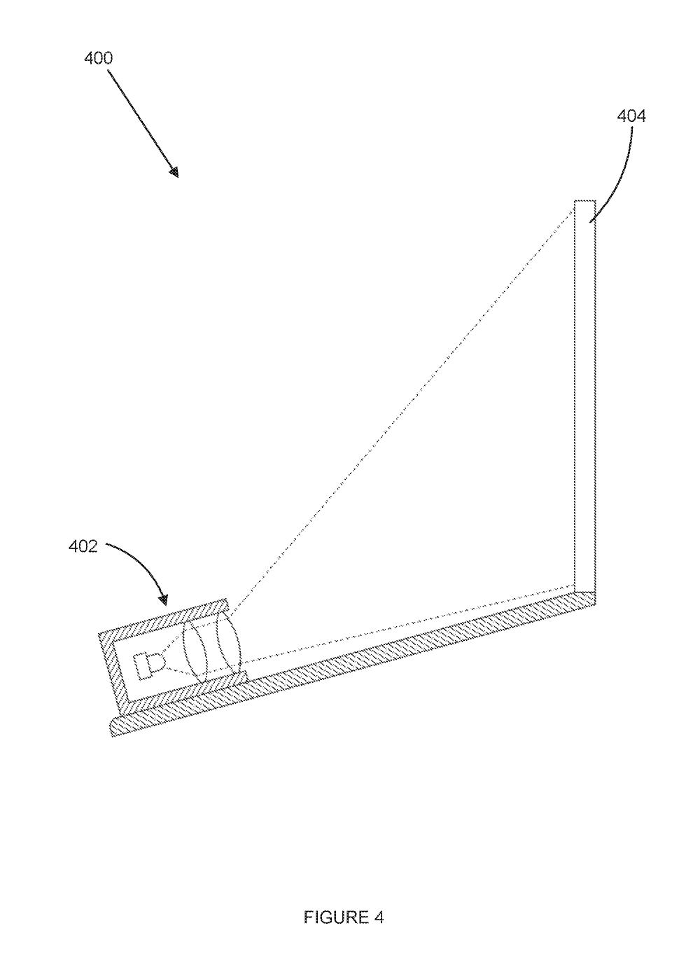

FIG. 4 illustrates an example vertical arrangement of a HUD 400, according to various embodiments. The HUD 400 may include one or more of the features of the HUD 100 (FIG. 1), the HUD system 200 (FIG. 2), the HUD 300 (FIG. 3), or some combination thereof. In particular, the HUD 400 may include a projection mechanism 402 and a combiner 404. The projection mechanism 402 may include one or more of the features of the projection mechanism 108 (FIG. 1), the projection mechanism 204 (FIG. 2), the projection mechanism 302 (FIG. 3), or some combination thereof. The combiner 404 may include one or more of the features of the combiner 110 (FIG. 1), the combiner 206 (FIG. 2), the combiner 308 (FIG. 3), or some combination thereof.

The combiner 404 may be positioned in a vertical arrangement. In the vertical arrangement, the combiner 404 may extend substantially vertical (within five degrees), which may be substantially perpendicular (within five degrees) to a line of sight of an observer (such as the observer 106 (FIG. 1)). In these embodiments, an arrangement of light emitted from the projection mechanism 402 may be projected at an angle to the combiner 404.

In some embodiments, the combiner 404 may be positioned at other angles than illustrated in FIG. 3 and FIG. 4. In particular, it is to be understood that the combiner 404 may extend at any angle between 0 and 180 degrees to the direction that the arrangement of light is emitted from the projection mechanism 402.

FIG. 5 illustrates an example mirrored arrangement of a HUD 500, according to various embodiments. The HUD 500 may include one or more feature of the HUD 100 (FIG. 1), the HUD system 200 (FIG. 2), the HUD 300 (FIG. 3), the HUD 400 (FIG. 4), or some combination thereof.

The HUD 500 may include a projection mechanism 502. The projection mechanism 502 may include one or more of the features of the projection mechanism 108 (FIG. 1), the projection mechanism 204 (FIG. 2), the projection mechanism 302 (FIG. 3), the projection mechanism 402 (FIG. 4), or some combination thereof. The projection mechanism 502 may include a mirror 504. A projection matrix 506 and/or projection optics 508 of the projection mechanism 502 may project the arrangement of light on the mirror 504, which may be in a direction different from which a combiner 510 of the HUD 500 is located. The mirror 504 may reflect the arrangement of light onto the first side 512 of the combiner 510, wherein the combiner 510 produces an image based on the arrangement of light on the second side 514 of the combiner 510.

The mirror 504 may be flat, curved, or some combination thereof. In some embodiments, the mirror 504 may be a folding mirror, which may be folded against another portion of the HUD 500 for storage. In particular, the mirror 504 may be attached to another portion of the HUD 500 via a hinge 516, wherein the hinge 516 allows the mirror 504 to be rotated about the hinge against the other portion of the HUD 500. In some embodiments, the mirror 504 may be coupled to a base 518 of the HUD 500, where the mirror 504 can be foled against the base 518 for storage. In other embodiments, the hinge 516 may be omitted, where the mirror 504 may be rigidly positioned with the projection mechanism 502 in some of these embodiments.

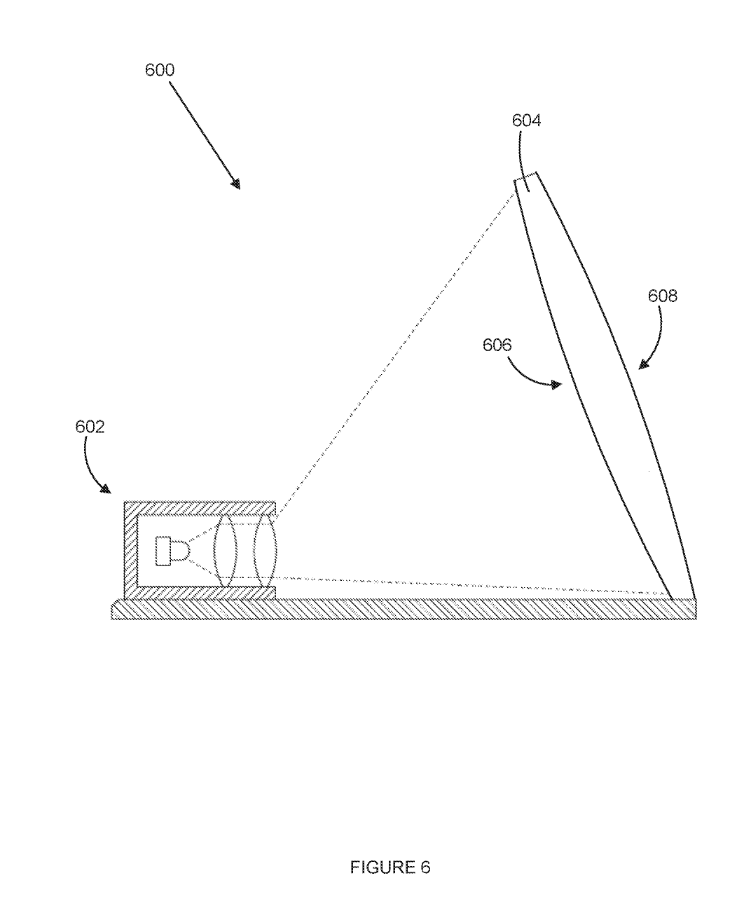

FIG. 6 illustrates another example arrangement of a HUD 600, according to various embodiments. The HUD 600 may include one or more of the features of the HUD 300 (FIG. 3). In particular, the HUD 600 includes a projection mechanism 602 that includes the features of the projection mechanism 302 (FIG. 3).

The HUD 600 further includes a combiner 604 may include one or more of the features of the combiner 110 (FIG. 1), the combiner 206 (FIG. 2), the combiner 308 (FIG. 3), the combiner 404 (FIG. 4), the combiner 510 (FIG. 5), or some combination thereof. The combiner 604 may have a first side 606 onto which an arrangement of light is projected by the projection mechanism 602. The combiner 604 may further have a second side 608 at which an image is produced by the arrangement of light being projected on the first side 606. In the illustrated embodiment, the first side 606 and the second side 608 are curved. In particular, the first side 606 and the second side 608 are convex in the illustrated embodiment. In other embodiments, the first side 606 and the second side 608 may be convex, concave, flat, or some combination thereof.

### Examples

Example 1 may include a heads up display for a vehicle, comprising a holographic transmissive combiner to be positioned on a dashboard of the vehicle, and a projection mechanism configured to project an arrangement of light on a first side of the holographic transmissive combiner, the holographic transmissive combiner configured to produce an image on a second side of the holographic transmissive combiner to be viewed by an observer, wherein the image is based on the arrangement of light.

Example 2 may include the heads up display of example 1 or some other example herein, wherein the holographic transmissive combiner is located between the projection mechanism and the observer.

Example 3 may include the heads up display of example 1 or some other example herein, wherein the holographic transmissive combiner is located between 25.4 centimeters and 76.2 centimeters from the observer.

Example 4 may include the heads up display of example 1 or some other example herein, wherein the holographic transmissive combiner is located between a windshield of the vehicle and the observer.

Example 5 may include the heads up display of example 1 or some other example herein, wherein the holographic transmissive combiner has a height between 12.7 centimeters and 50.8 centimeters.

Example 6 may include the heads up display of example 1 or some other example herein, wherein the holographic transmissive combiner has a width between 12.7 centimeters and 63.5 centimeters.

Example 7 may include the heads up display of example 1 or some other example herein, wherein the first side of the holographic transmissive combiner is flat and the second side of the holographic transmissive combiner is flat.

Example 8 may include the heads up display of example 1 or some other example herein, wherein the first side of the holographic transmissive combiner is curved.

Example 9 may include the heads up display of example 1 or some other example herein, wherein the second side of the holographic transmissive combiner is curved.

Example 10 may include the heads up display of example 1 or some other example herein, wherein the heads up display further includes a base to which the holographic transmissive combiner and the projection mechanism are coupled, wherein the base is configured to maintain a distance between the holographic transmissive combiner and the projection mechanism.

Example 11 may include the heads up display of example 1 or some other example herein, wherein the heads up display further includes a base to which the holographic transmissive combiner and the projection mechanism are coupled, wherein the holographic transmissive combiner is configured to be folded against the base for storage.

Example 12 may include the heads up display of example 1 or some other example herein, wherein the heads up display further includes a display controller that is communicatively coupled to a computer system of the vehicle and the projection mechanism, wherein the display controller is configured to retrieve information from the computer system that is to be displayed within the image, and wherein the display controller it configured to transmit a signal to the projection mechanism that causes the projection mechanism to project the arrangement of light that corresponds to the information.

Example 13 may include the heads up display of example 1 or some other example herein, wherein the heads up display further includes a display controller that is communicatively coupled to a communication system and the projection mechanism, wherein the display controller is configured to retrieve information from the communication system that is to be displayed within the image, and wherein the display controller it configured to transmit a signal to the projection mechanism that causes the projection mechanism to project the arrangement of light that corresponds to the information.

Example 14 may include the heads up display of example 1 or some other example herein, wherein the projection mechanism includes projection optics and a projection matrix to generate the arrangement of light and project the arrangement of light on the projection optics, wherein the projection optics is configured to project the arrangement of light as the arrangement of light passes through the projection optics.

Example 15 may include the heads up display of example 14 or some other example herein, wherein the projection mechanism further includes a mirror, wherein the projection optics is configured to project the arrangement of light on the mirror, and wherein the mirror is to reflect the arrangement of light onto the first side of the combiner.

Example 16 may include the heads up display of example 15 or some other example herein, wherein the heads up display further includes a base to which the mirror is coupled, and wherein the mirror is configured to be folded against the base for storage.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A heads up display for a vehicle, comprising:
a holographic transmissive combiner to be positioned on a dashboard of the vehicle; and
a projection mechanism configured to project an arrangement of light on a first side of the holographic transmissive combiner, the holographic transmissive combiner configured to produce an image on a second side of the holographic transmissive combiner to be viewed by an observer, wherein the image is based on the arrangement of light.

2. The heads up display of claim 1, wherein the holographic transmissive combiner is located between the projection mechanism and the observer.

3. The heads up display of claim 1, wherein the holographic transmissive combiner is located between 25.4 centimeters and 114.3 centimeters from the observer.

4. The heads up display of claim 1, wherein the holographic transmissive combiner is located between a windshield of the vehicle and the observer.

5. The heads up display of claim 1, wherein the holographic transmissive combiner has a height between 2.54 centimeters and 25.4 centimeters.

6. The heads up display of claim 1, wherein the holographic transmissive combiner has a width between 7.62 centimeters and 63.5 centimeters.

7. The heads up display of claim 1, wherein the first side of the holographic transmissive combiner is flat and the second side of the holographic transmissive combiner is flat.

8. The heads up display of claim 1, wherein the first side of the holographic transmissive combiner is curved.

9. The heads up display of claim 1, wherein the second side of the holographic transmissive combiner is curved.

10. The heads up display of claim 1, wherein the heads up display further comprises a base to which the holographic transmissive combiner and the projection mechanism are coupled, wherein the base is configured to maintain a distance between the holographic transmissive combiner and the projection mechanism.

11. The heads up display of claim 1, wherein the heads up display further comprises a base to which the holographic transmissive combiner and the projection mechanism are coupled, wherein the holographic transmissive combiner is configured to be folded against the base for storage.

12. The heads up display of claim 1, wherein the heads up display further comprises a display controller that is communicatively coupled to a computer system of the vehicle and the projection mechanism, wherein the display controller is configured to retrieve information from the computer system that is to be displayed within the image, and wherein the display controller is configured to transmit a signal to the projection mechanism that causes the projection mechanism to project the arrangement of light that corresponds to the information.

13. The heads up display of claim 1, wherein the heads up display further comprises a display controller that is communicatively coupled to a communication system and the projection mechanism, wherein the display controller is configured to retrieve information from the communication system that is to be displayed within the image, and wherein the display controller is configured to transmit a signal to the projection mechanism that causes the projection mechanism to project the arrangement of light that corresponds to the information.

14. The heads up display of claim 1, wherein the projection mechanism comprises:
projection optics; and
a projection matrix to generate the arrangement of light and project the arrangement of light on the projection optics, wherein the projection optics is configured to project the arrangement of light as the arrangement of light passes through the projection optics.

15. The heads up display of claim 14, wherein the projection mechanism further comprises a mirror, wherein the projection optics is configured to project the arrangement of light on the mirror, and wherein the mirror is to reflect the arrangement of light onto the first side of the combiner.

16. The heads up display of claim 15, wherein the heads up display further comprises a base to which the mirror is coupled, and wherein the mirror is configured to be folded against the base for storage.
